(19) United States
(12) Patent Application Publication
(10) Pub. No.: US 2025/0246843 A1
(43) Pub. Date: Jul. 31, 2025

(54) POWER CONNECTOR AND TERMINAL ASSEMBLY

(71) Applicant: BELLWETHER ELECTRONIC CORP., Taoyuan City (TW)

(72) Inventor: TAI-CHING SUNG, Taoyuan City (TW)

(21) Appl. No.: 18/642,756

(22) Filed: Apr. 22, 2024

(30) Foreign Application Priority Data
Jan. 26, 2024 (TW) 113103063

(51) Int. Cl. H01R 13/50; H01R 13/11; H01R 13/187

(52) U.S. Cl. CPC H01R 13/50; H01R 13/112; H01R 13/187

(57) ABSTRACT

A power connector includes an insulating seat and two terminal assemblies. The insulating seat includes two supporting arms that are disposed at one side thereof and are spaced apart from each other. A slot is disposed between the two supporting arms. Each of the two terminal assemblies includes a conductive axial column, a conductive member, and at least one elastic conductive structure. The conductive axial column is disposed in the insulating seat. One end of the conductive member is electrically connected to the conductive axial column, and another end of the conductive member is exposed from the slot. The elastic conductive structure, the conductive axial column, and the conductive member are electrically connected to each other. When a power supply component is inserted into the slot, the conductive member abutted by the power supply component can rotate relative to the insulating seat through the conductive axial column.

### CROSS-REFERENCE TO RELATED PATENT APPLICATION

This application claims the benefit of priority to Taiwan Patent Application No. 113103063, filed on Jan. 26, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a connector and a terminal assembly thereof, and more particularly to a power connector and a terminal assembly thereof.

### BACKGROUND OF THE DISCLOSURE

A conventional power connector is usually applied in a server. In order for the power connector to transmit a larger current, a relevant manufacturer may increase a cross-sectional area of a plurality of conductive elastic arms in the power connector. In response to the increase of the cross-sectional area of the conductive elastic arms, an overall thickness of the conductive elastic arms is also increased.

In practice, when the thickness of the conductive elastic arms is increased to a certain extent, it generates an excessive normal force between the two conductive elastic arms of the power connector and a clamped power supply component of a power supplier. It may be hard to mate with or cause abrasion of the power supply component, thereby negatively affecting the usage count and the service life of the power supply component.

### SUMMARY OF THE DISCLOSURE

In response to the above-referenced technical inadequacies, the present disclosure provides a power connector that can improve a conventional power connector, so as to transmit a large current and ensure provision of a suitable normal force for clamping a power supply component.

In order to solve the above-mentioned problems, one of the technical aspects adopted by the present disclosure is to provide a power connector. The power connector includes an insulating seat and two terminal assemblies. The insulating seat includes two supporting arms disposed at one side thereof. The two supporting arms are spaced apart from each other, and a slot is disposed between the two supporting arms. Each of the two terminal assemblies includes a conductive axial column, a conductive member, and at least one elastic conductive structure. The conductive axial column is disposed in the insulating seat. One end of the conductive member is electrically connected to the conductive axial column, and another end of the conductive member is exposed from the slot. The at least one elastic conductive structure is disposed between the conductive axial column and the conductive member. The at least one elastic conductive structure is electrically connected to the conductive axial column and the conductive member, and the at least one elastic conductive structure includes at least one elastic structure. When a power supply component is inserted into the slot, each of the conductive members abutted by the power supply component is configured to rotate relative to the insulating seat through one of the conductive axial columns.

In order to solve the above-mentioned problems, another one of the technical aspects adopted by the present disclosure is to provide a power connector. The power connector includes an insulating seat and two terminal assemblies. The insulating seat has a slot disposed at one side thereof. The two terminal assemblies are electrically insulated from each other and disposed in the insulating seat. Two ends of the two terminal assemblies are respectively disposed at two sides of the slot, and each of the two terminal assemblies includes a conductive axial column, a conductive member, and at least one conductive connection sheet. The conductive axial column is disposed in the insulating seat. The conductive member has one end electrically connected to the conductive axial column and is configured to rotate or move relative to the conductive axial column. Another end of the conductive member is exposed from the slot. The at least one conductive connection sheet is disposed in the insulating seat. The at least one conductive connection sheet is connected to the conductive axial column and configured to be connected to a cable assembly.

In order to solve the above-mentioned problems, yet another one of the technical aspects adopted by the present disclosure is to provide a terminal assembly. The terminal assembly includes a conductive axial column, a conductive member, and at least one elastic conductive structure. The conductive member has one end electrically connected to the conductive axial column. The conductive member includes a plurality of elastic arms at another end thereof. The at least one elastic conductive structure is disposed between the conductive axial column and the conductive member. The at least one elastic conductive structure, the conductive axial column, and the conductive member are electrically connected to each other, and the at least one elastic conductive structure includes at least one elastic structure. The conductive member is configured to rotate or move relative to the conductive axial column.

Therefore, in the power connector and the terminal assembly provided by the present disclosure, through configuration of the conductive axial column, the conductive member, and the elastic conductive structure, the conductive member can rotate through the conductive axial column after being abutted against. Accordingly, the power connector can transmit a large current, and can also achieve an effect of stably clamping the power supply component.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 and FIG. 2 are schematic views of a power connector according to a first embodiment of the present disclosure taken from different angles of view;

FIG. 3 is a schematic partial cross-sectional view of the power connector that is partly exploded according to the first embodiment of the present disclosure;

FIG. 4 is a schematic exploded view of one of a plurality of terminal assemblies of the power connector according to the first embodiment of the present disclosure;

FIG. 5 is a schematic partial exploded view of one of the terminal assemblies of the power connector according to the first embodiment of the present disclosure;

FIG. 6 is a schematic view of an elastic conductive structure of the power connector according to the first embodiment of the present disclosure;

FIG. 7 is a schematic cross-sectional view taken along line VII-VII of FIG. 1;

FIG. 8 is a schematic cross-sectional view showing a power supply component being mated with the power connector according to the first embodiment of the present disclosure;

FIG. 9 is a schematic partial cross-sectional view of an insulating seat and a plurality of auxiliary conductive members of the power connector that are partly exploded according to the first embodiment of the present disclosure;

FIG. 10 is a schematic view of the auxiliary conductive member of the power connector according to the first embodiment of the present disclosure;

FIG. 11 is schematic view of the power connector according to a second embodiment of the present disclosure;

FIG. 12 is a schematic partial cross-sectional view of the power connector according to the second embodiment of the present disclosure;

FIG. 13 is a side view of FIG. 12;

FIG. 14 is a schematic exploded view of the terminal assembly of the power connector according to the second embodiment of the present disclosure;

FIG. 15 and FIG. 16 are two schematic partial enlarged views of FIG. 14;

FIG. 17 is a schematic view of the power connector according to a third embodiment of the present disclosure;

FIG. 18 is a schematic partial exploded view of the power connector according to the third embodiment of the present disclosure; and

FIG. 19 is a schematic view of the terminal assemblies and one portion of the insulating seat of the power connector according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

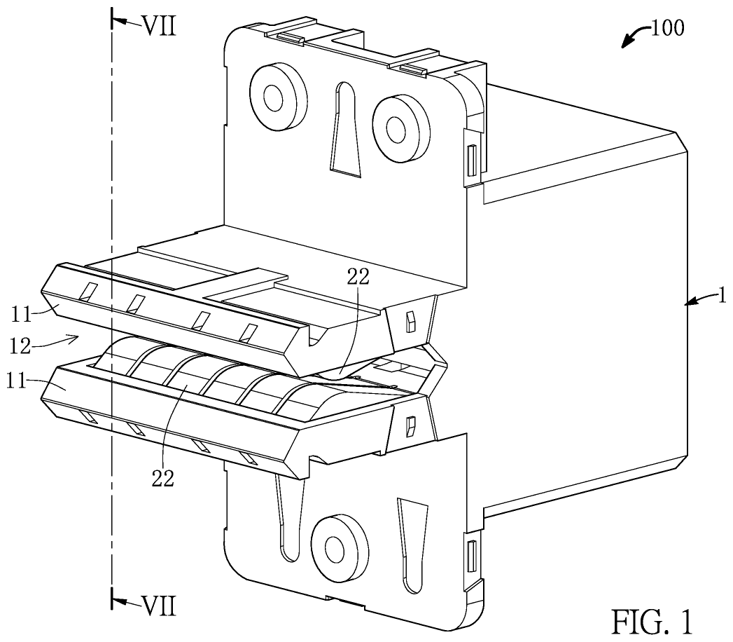

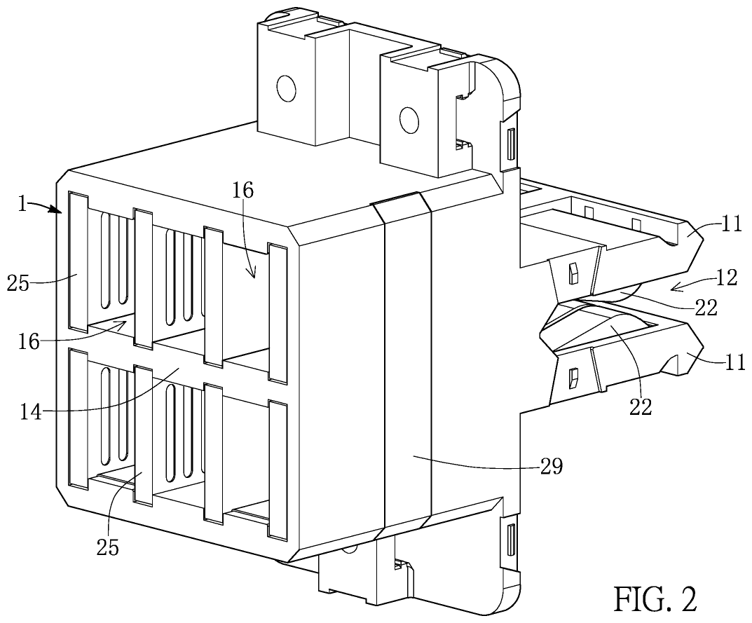

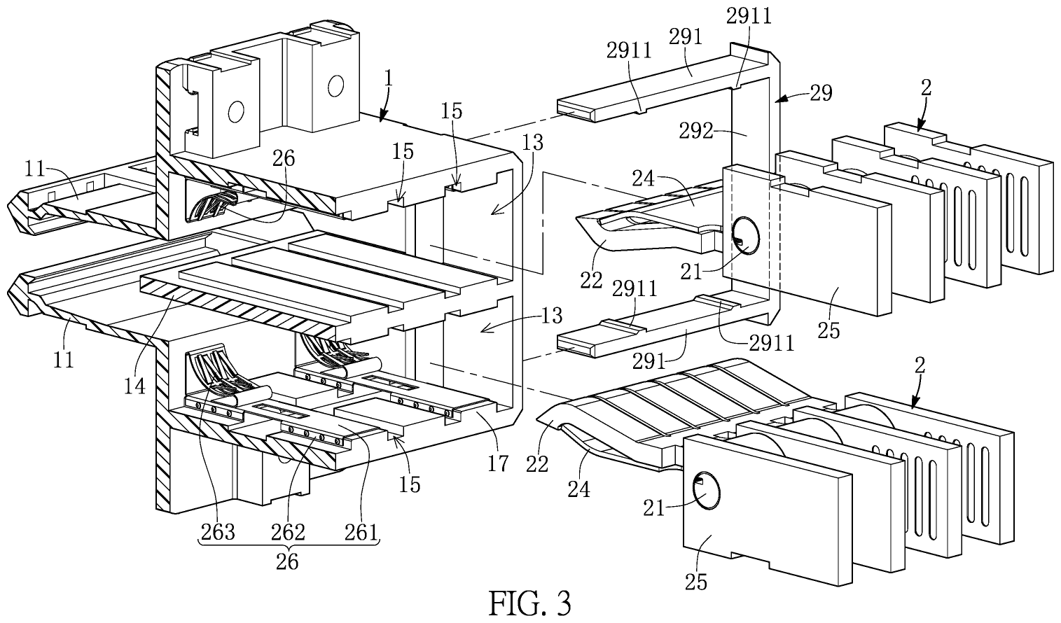

Referring to FIG. 1 to FIG. 3, FIG. 1 and FIG. 2 are schematic views of a power connector according to a first embodiment of the present disclosure taken from different angles of view, and FIG. 3 is a schematic partial cross-sectional view of the power connector that is partly exploded according to the first embodiment of the present disclosure. The present disclosure provides a power connector 100 that includes an insulating seat 1 and two terminal assemblies 2. The insulating seat 1 includes two supporting arms 11 at one side thereof, the two supporting arms 11 are spaced apart from each other, and a slot 12 is formed between the two supporting arms 11. Two accommodating spaces 13 are formed within the insulating seat 1, and the two terminal assemblies 13 are electrically insulated with each other and fixed in the two accommodating spaces 13 of the insulating seat 1. The insulating seat 1 includes a baffle 14 arranged between the two accommodating spaces 13, such that the two terminal assemblies 13 are electrically insulated with each other.

The two terminal assemblies 2 are respectively connected to two cable assemblies, and can be respectively connected to different electric potential ends of a power supplier.

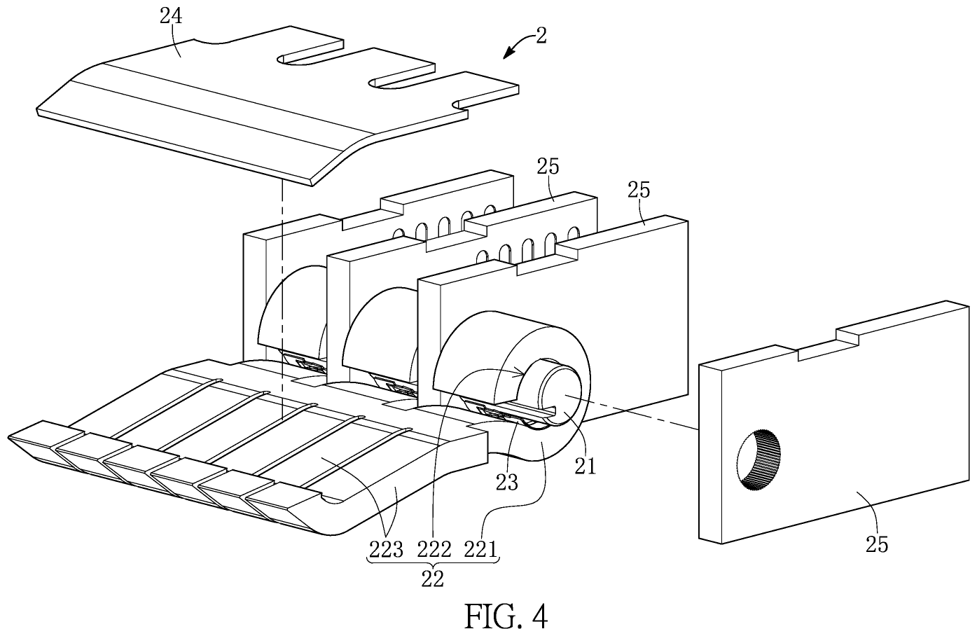

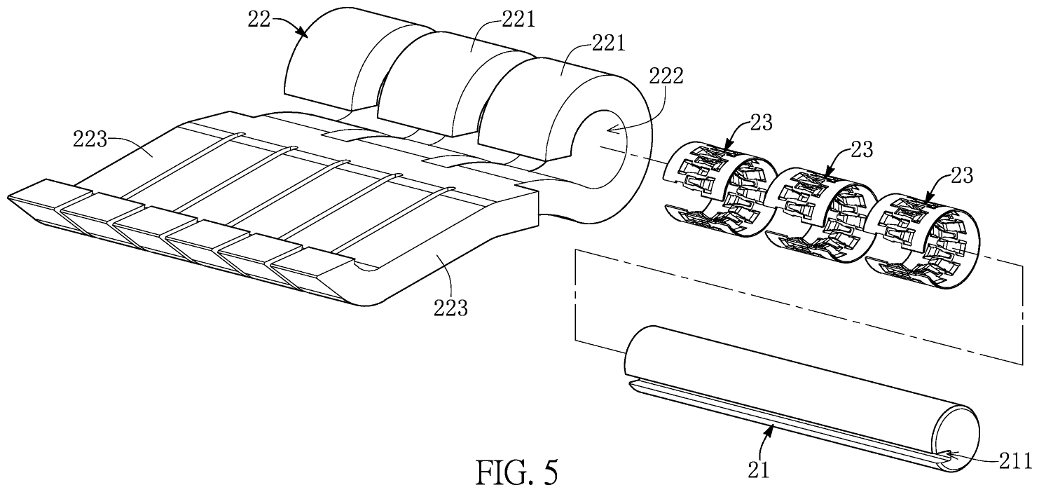

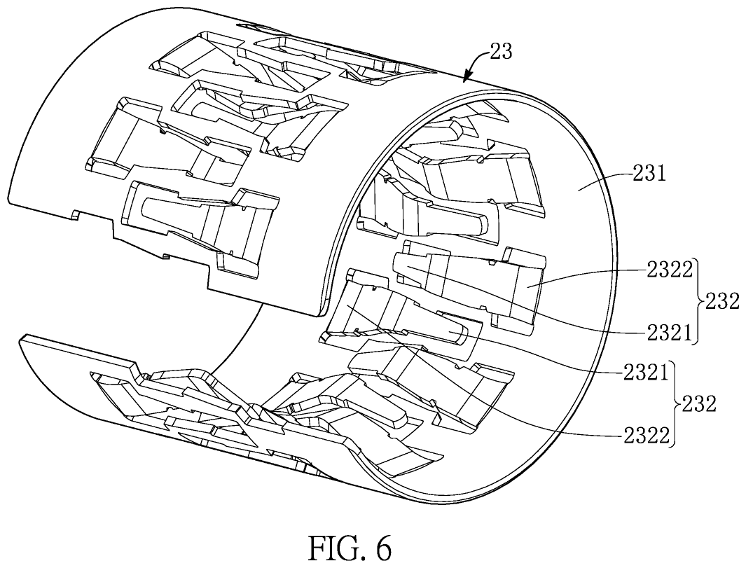

Referring to FIG. 1 and FIG. 3 to FIG. 6, FIG. 4 is a schematic exploded view of one of a plurality of terminal assemblies of the power connector according to the first embodiment of the present disclosure, FIG. 5 is a schematic partial exploded view of one of the terminal assemblies of the power connector according to the first embodiment of the present disclosure, and FIG. 6 is a schematic view of an elastic conductive structure of the power connector according to the first embodiment of the present disclosure. Each of the terminal assemblies 2 includes at least one conductive axial column 21, at least one conductive member 22, and at least one elastic conductive structure 23. In the present embodiment, each of the terminal assemblies 2 includes one conductive axial column 21, one conductive member 22, and three elastic conductive structures 23.

The conductive axial column 21 is fixed in the insulating seat 1. The conductive axial column 21 can have a cylinder structure (e.g., a cylinder copper rod). Two ends of the conductive axial column 21 can be directly or indirectly fixed to the insulating seat 1 (i.e., the conductive axial column 21 does not move relative to the position of the insulating seat 1) in an engaging manner, an adhering manner, or a soldering manner. One end of the conductive member 22 is electrically connected to the conductive axial column 21, and the conductive member 22 includes a plurality of elastic arms at another end thereof. The three elastic conductive structures 23 are disposed between the conductive member 22 and the conductive axial column 21, such that the conductive axial column 21 and the conductive member 22 can move relative to each other. In other words, during relative rotation of the conductive axial column 21 and the conductive 22, during movement of a surface of the conductive axial column 21 and a surface of the conductive member 22, or during a combined movement thereof, the conductive member 22 and the conductive axial column 21 can maintain electrical connection through the elastic conductive structures 23. Referring to FIG. 5 and FIG. 6, each of the elastic conductive structures 23 can be a conductive sheet, and can be bent into a substantially cylindrical structure. Each of the elastic conductive structures 23 has at least one elastic structure formed thereon. The conductive sheet includes a sheet body 231 and the at least one elastic structure. The elastic structure is an elastic arm 232. A root portion 2322 is disposed at one end of each of the elastic arms 232, and is connected to the sheet body 231. Another end of each of the elastic arms 232 can be a free end, or can be connected to the sheet body 231. In an exemplary application, a free end 2321 of each of the elastic arms 232 is disposed adjacent to the root portion 2322 of an adjacent one of the elastic arms 232. In other words, except the two elastic arms 232 at two outermost sides of the elastic conductive structures 23, the free end 2321 of each of the elastic arms 232 is disposed between the two root portions 2322 of another two of the elastic arms 232.

When the elastic conductive structures 23 are disposed between the conductive axial column 21 and the conductive member 22, each of the elastic arms 232 are pressed and elastically deformed, such that an ability to conduct large current is provided between the conductive member 22 and the conductive axial column 21. As shown in FIG. 5, in one embodiment, one end of each of the conductive members 22 can bend to form three bend fixing portions 221, a hollow accommodating slot 222 is formed within each of the bend fixing portions 221, the hollow accommodating slots 222 are arranged in line to form a tunnel, and the tunnel is configured to accommodate the conductive axial column 21 and the three elastic conductive structures 23. The quantity of the bend fixing portions 221 corresponds to the quantity of the elastic conductive structures 23. That is, each of the hollow accommodating slots 222 is configured to accommodate one or more elastic conductive structures 23. An overall structure of each of the hollow accommodating slots 222 can be substantially cylindrical. The conductive members 22 are connected to the conductive axial column 21 through the elastic conductive structures 23. When another end of the conductive members 22 is abutted by an external force, the overall conductive members 22 can rotate relative to the conductive axial column 21.

Another end of each of the conductive members 22 is disposed at one of the supporting arms 11, and is partially exposed from the supporting arm 11. The exposed two portions of the two conductive members 22 of the two terminal assemblies 2 face toward each other. In a practical application, each of the conductive members 22 has a plurality of connection arms 223 disposed at another end thereof, and a gap is formed between two adjacent ones of the connection arms 223. In a practical application, each of the terminal assemblies 2 can further include an elastic member 24. One end of the elastic member 24 is fixed to one of the terminal assemblies 2 or the insulating seat 1. For example, the one end of the elastic member 24 can be engaged in a groove 211 of the conductive axial column 21. Or, the one end of the elastic member 24 can be engaged with a related structure (e.g., a groove, not shown) in the insulating seat 1. Another end of each of the elastic members 24 is disposed inside one of the supporting arms 11, and is disposed at an outer side of the connection arms 223 of the conductive member 22. When the conductive member 22 moves or rotates relative to the conductive axial column 21 and is elastically deformed, the elastic member 24 can provide a force to the conductive member 22 in another direction (i.e., toward the slot 12) to resist the deformation. The elastic member 24 can be made of an elastic material (e.g., stainless steel).

A thickness of each of the elastic members 24 is less than a thickness of each of the conductive members 22. For example, the thickness of each of the conductive members 22 is greater than 1.5 mm, and the thickness of each of the elastic members 24 can be less than 1 mm (e.g., 0.8 mm). In addition, the thickness of each of the conductive members 22 can be adjusted according to an amount of a current that the power connector 100 needs to carry. For example, the thickness of each of the conductive members 22 can be greater than 3 mm.

In an example where the power connector 100 is not provided with the elastic members 24, the position of the rotated conductive members 22 can be limited by the supporting arms 11, so as to ensure that the conductive members 22 can still stably clamp a power supply component A1 of a power supply system A with a suitable normal force after rotation of the conductive members 22.

In a practical application, each of the terminal assemblies 2 further includes a plurality of conductive connection sheets 25 that are spaced apart from each other and disposed in the insulating seat 1. Each of the conductive connection sheets 25 is electrically connected to the conductive axial column 21. In a practical application, each of the conductive connection sheets 25 can be fixedly connected to the conductive axial column 21, such that the conductive axial column 21 cannot rotate. Each of the conductive connection sheets 25 can have a board shape, at least one portion of each of the conductive connection sheets 25 is disposed in a gap between two adjacent ones of the bend fixing portions 221, and each of the conductive connection sheets 25 is perpendicular to a long axial direction of the conductive axial column 21. The insulating seat 1 can have a plurality of engaging slots 15 in each of the accommodating spaces 13. Each of the engaging slots 15 and another one of the engaging slots 15 face toward each other, and are disposed at two opposite sides of the accommodating spaces 13. Two ends of each of the conductive connection sheets 25 are engaged in two of the engaging slots 15 that face toward each other. In practice, each of the conductive connection sheets 25 and two of the engaging slots 15 can be fixed by tight fit. After the conductive connection sheets 25 are fixedly disposed in the two accommodating spaces 13, a plurality of cable slots 16 (as shown in FIG. 2) are defined. Each of the cable slots 16 is configured to accommodate one or more cables connected to the conductive connection sheets 25. The two terminal assemblies 2 can be respectively connected to the two cable assemblies, each of the cable assemblies includes at least one cable, and the two terminal assemblies 2 and the two cable assemblies can each transmit currents having different electric potentials. It is worth mentioning that, in a practical application, the quantity of the conductive connection sheets 25 included in each of the terminal assemblies 2 and the quantity of the cables can be increased or decreased, so as to adjust a maximum amount of the current that can be transmitted by the cable connected to each of the terminal assemblies 2.

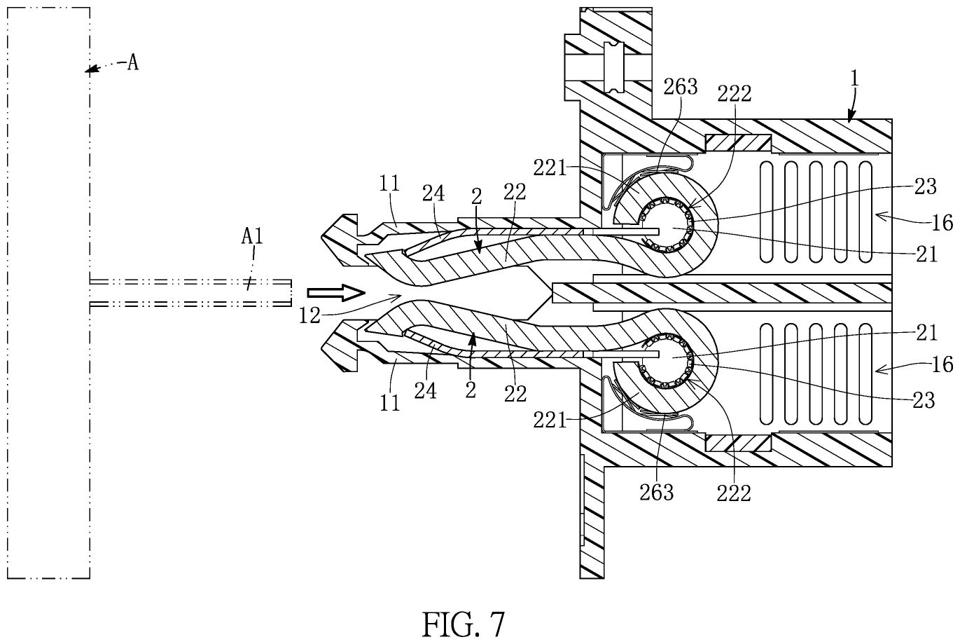

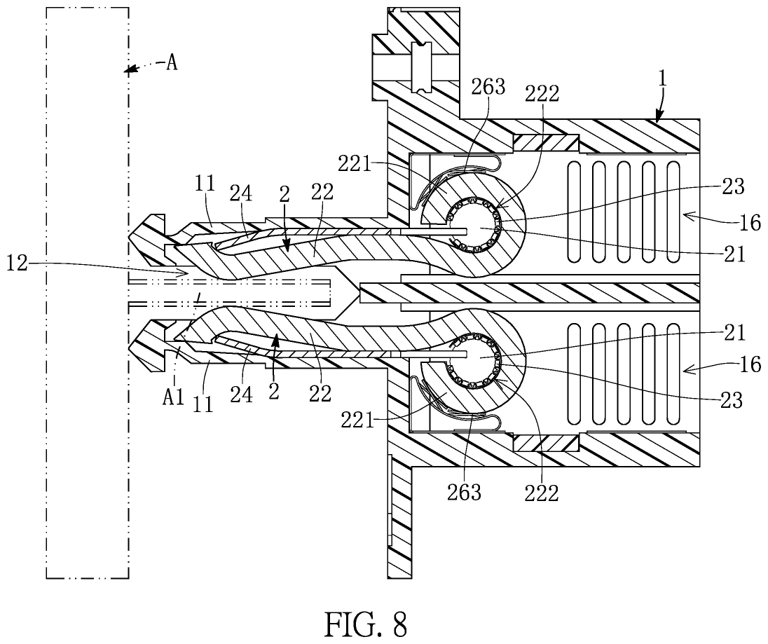

Referring to FIG. 4 to FIG. 8, FIG. 7 is a schematic cross-sectional view taken along line VII-VII of FIG. 1, and FIG. 8 is a schematic cross-sectional view showing a power supply component being mated with the power connector according to the first embodiment of the present disclosure. After the two terminal assemblies 2 are disposed in the insulating seat 1, the two portions of the two conductive members 22 that are exposed from the supporting arms 11 are disposed in the slot 12, and an insertion gap is formed between the two conductive members 22 disposed in the slot 12. When the power supply component A1 is not inserted into the slot 12, the insertion gap is less than a thickness of the power supply component A1 of the power supply system A.

As shown in FIG. 7 and FIG. 8, when the power connector 100 is mated with the power supply system A, and the power supply component A1 is correspondingly inserted into the slot 12, the power supply component A1 abuts against portions of the two conductive members 22 that are exposed from the slot 12, such that each of the conductive members 22 rotates relative to the insulating seat 1 round a corresponding one of the conductive axial columns 21. The elastic member 24 disposed at one side of each of the conductive members 22 is pushed by the conductive member 22, and is elastically deformed toward an outer side, such that each of the elastic members 24 simultaneously provides a normal force for clamping the power supply component A1. In this way, the two conductive members 22 stably clamp the power supply component A1 by being subjected to an elastic returning force of the two elastic members 24.

In other words, in the power connector 100 of the present disclosure, a primary source of the normal force for the two conductive members 22 to clamp the power supply component A1 is the elastic returning force of the two elastic members 24 after being pressed. An elastic returning force of the two conductive members 22 after being pressed is less than the elastic returning force of the two elastic members 24. Through the above-mentioned configuration, the conductive members 22 are not the primary source of the force for clamping the power supply component A1. As such, the thickness of each of the conductive members 22 can be increased according to the amount of the current carried by the power connector 100. In addition, the conductive members 22 can rotate relative to the insulating seat 1. When the thickness of the conductive members 22 is increased, the normal force applied to the power supply component A1 by the two conductive members 22 is not significantly increased. Accordingly, when the power connector 100 transmits a large current, provision of a suitable clamping force for clamping the power supply component of the power supplier can also be ensured.

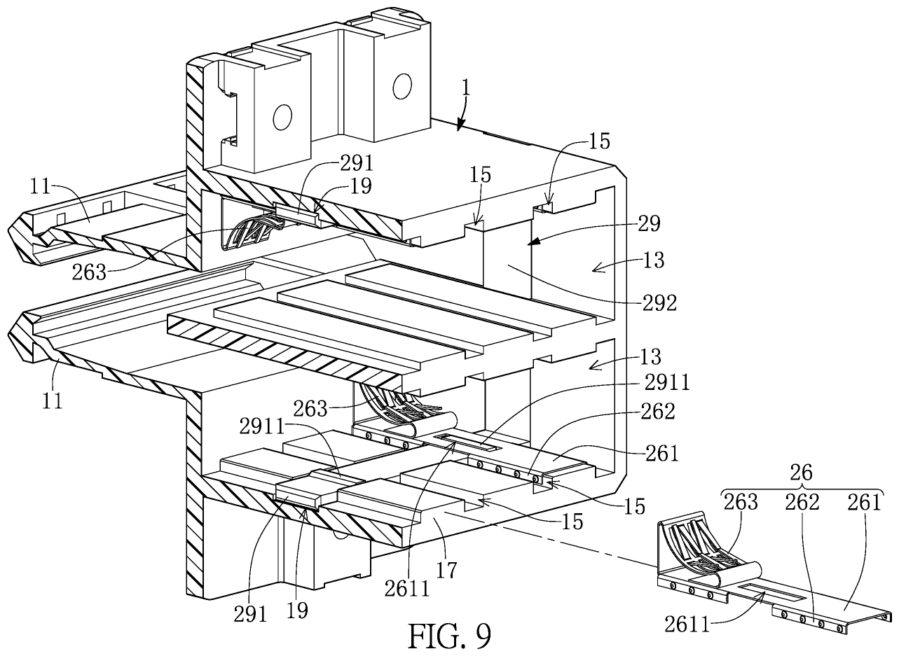

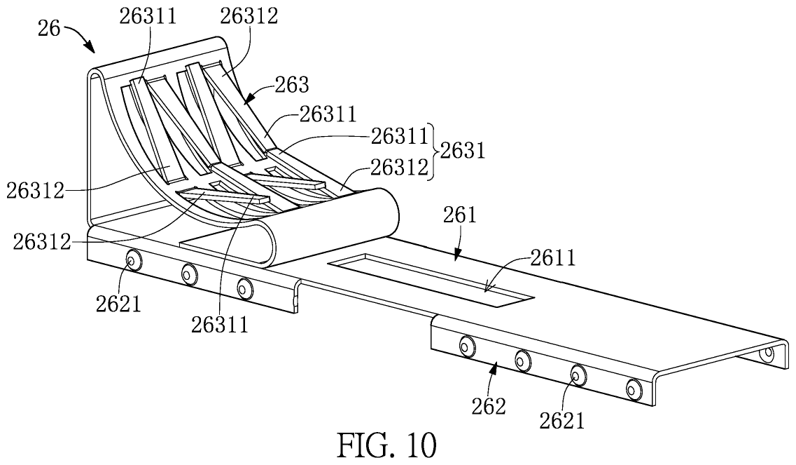

Referring to FIG. 7 to FIG. 10, FIG. 9 is a schematic partial cross-sectional view of an insulating seat and a plurality of auxiliary conductive members of the power connector that are partly exploded according to the first embodiment of the present disclosure, and FIG. 10 is a schematic view of the auxiliary conductive member of the power connector according to the first embodiment of the present disclosure. In a practical application, the power connector 100 can further include a plurality of auxiliary conductive members 26 disposed in the two accommodating spaces 13 of the insulating seat 1.

Each of the auxiliary conductive members 26 is electrically connected to one of the conductive members 22 and at least one of the conductive connection sheets 25, so as to increase a maximum amount of the current that transmits from the conductive members 22 to the conductive connection sheets 25. Each of the auxiliary conductive members 26 can include a board body 261, a plurality of fixing portions 262, and an arced sheet structure 263. Two sides of the board body 261 extend in a same direction to form the fixing portions 262, and the board body 261 and the fixing portions 262 can overall have a shape similar to the letter “U”. The insulating seat 1 has a protrusion 17 between any two adjacent ones of the engaging slots 15, the board body 261 of each of the auxiliary conductive members 26 is disposed on a top surface of the protrusion 17, and the fixing portions 262 are correspondingly disposed in the engaging slots 15. Each of the fixing portions 262 can have a plurality of bump structures 2621 disposed at one outer side thereof, and the bump structures 2621 are configured to enhance the connection between the fixing portions 262 and the conductive connection sheet 25. One portion of each of the auxiliary conductive members 26 is jointly clamped by the insulating seat 1 and the conductive connection sheet 25. In a practical application, a power connector 100 can further include an engaging member 29 that is configured to be engaged in the insulating seat 1. The engaging member 29 can include two arm portions 291 and a connection portion 292, two ends of the connection 292 are connected to the two arm portions 291, and the overall engaging member 29 substantially has a shape of the letter “C.” The insulating seat 1 can include two engaging slots 19. When the engaging member 29 is fixed in the insulating seat 1, the two arm portions 291 are correspondingly engaged in the two engaging slots 19. Each of the arm portions 291 can further include a first auxiliary engaging structure 2911, the board body 261 of each of the auxiliary conductive members 26 can correspondingly include a second auxiliary engaging structure 2611, and the first auxiliary engaging structure 2911 is configured to be engaged with the second auxiliary engaging structure 2611. For example, each of the first auxiliary engaging structures 2911 and each of the second auxiliary engaging structures 2611 can be a protrusion and a thru-hole, respectively.

The arced sheet structure 263 is disposed at one end of each of the auxiliary conductive members 26, the arced sheet structure 263 includes a plurality of elastic structures disposed thereon, and the elastic structures 2631 are configured to abut against the bend fixing portion 221 of one of the conductive members 22. One end of each of the elastic structures 2631 can be a free end 26311, and the free end 26311 is disposed adjacent to a root portion 26312 of an adjacent one of the elastic structures 2631.

As shown in FIG. 3, FIG. 7, and FIG. 9, when the two terminal assemblies 2 are disposed in the two accommodating spaces 13, each of the arced sheet structures 263 abuts against an outer surface of the bend fixing portion 221 of a corresponding one of the conductive members 22, and each of the elastic structures 2631 is pressed to generate the elastic returning force. Since the elastic conductive structures 23 and the auxiliary conductive members 26 are respectively and electrically connected to an inner surface and the outer surface of the bend fixing portion 221, electrical connection paths between the conductive member 22 and the conductive connection sheet 25 can be increased, thereby lowering an overall impedance value of each of the terminal assemblies 2 and the heat generated during conduction of a large current. In a situation where the power connector 100 is carrying a large current (e.g., greater than 500 amps), the auxiliary conductive members 26 can prevent an overheating problem of the conductive members 22.

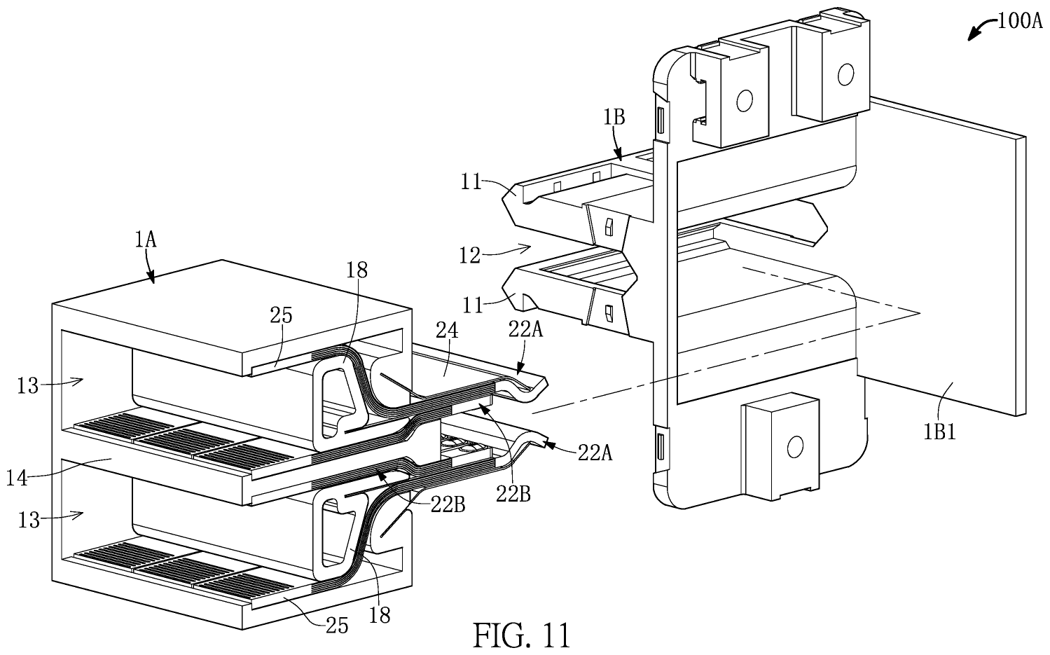

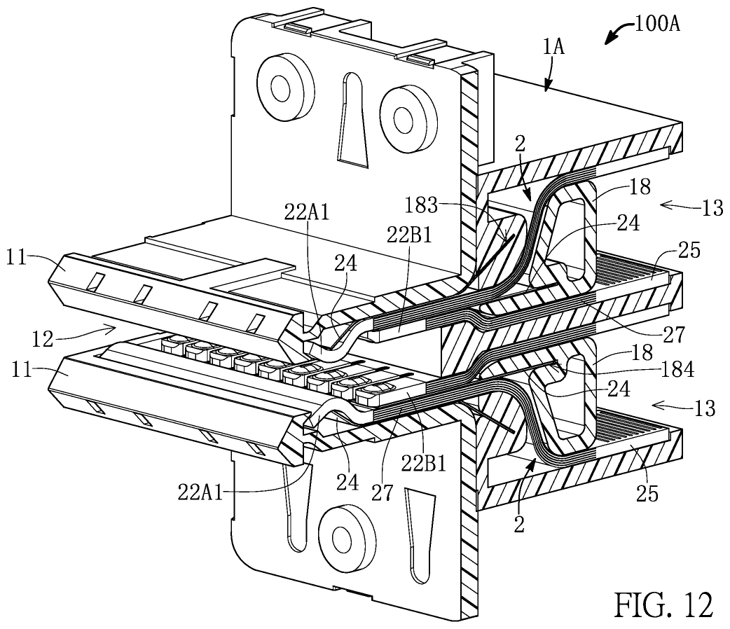

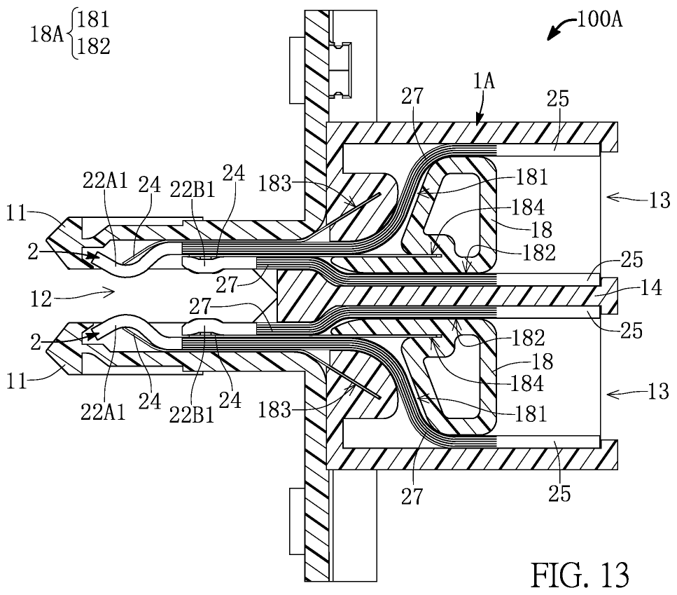

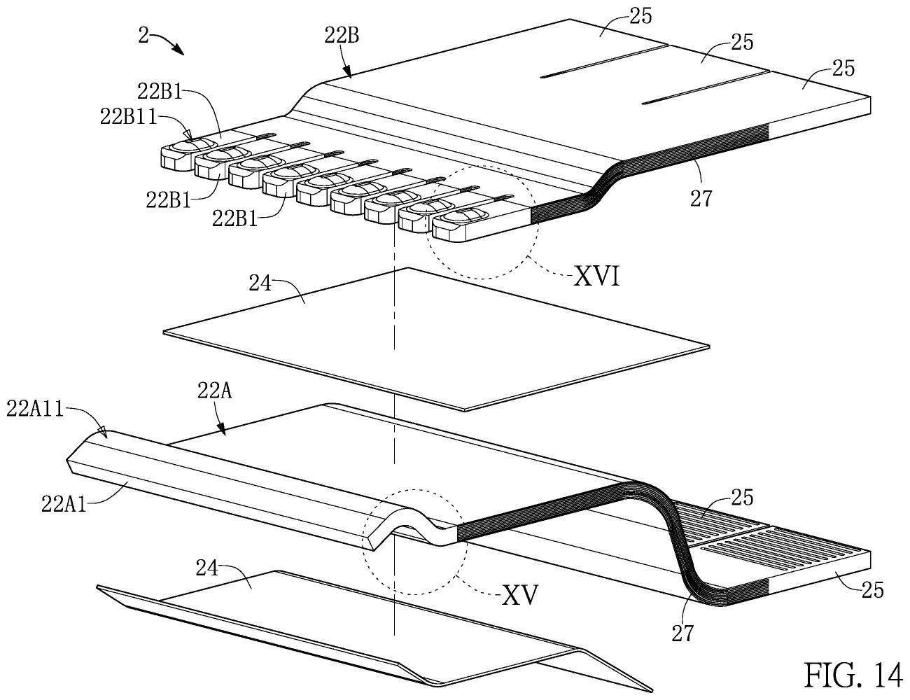

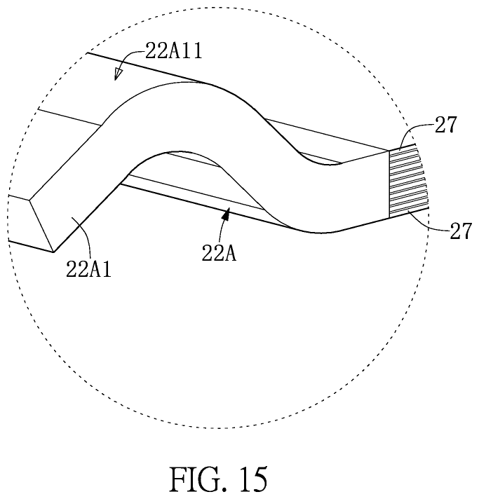

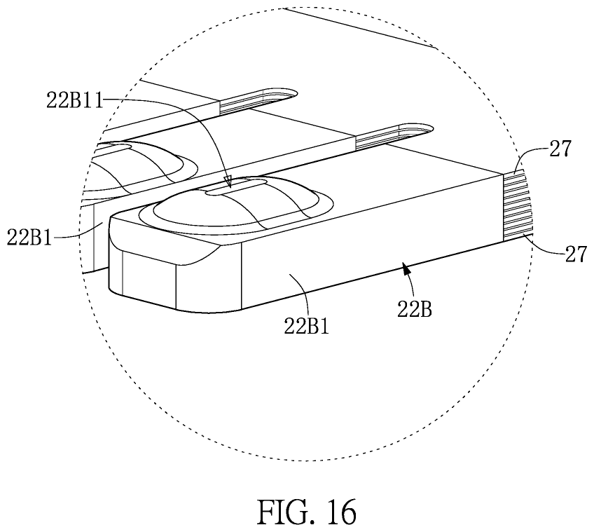

Referring to FIG. 11 to FIG. 16, FIG. 11 is schematic view of the power connector according to a second embodiment of the present disclosure, FIG. 12 is a schematic partial cross-sectional view of the power connector according to the second embodiment of the present disclosure, FIG. 13 is a side view of FIG. 12, FIG. 14 is a schematic exploded view of the terminal assembly of the power connector according to the second embodiment of the present disclosure, and FIG. 15 and FIG. 16 are two schematic partial enlarged views of FIG. 14.

The power connector 100A of the present disclosure includes the insulating seat 1 and the two terminal assemblies 2 disposed in the insulating seat 1. Each of the terminal assemblies 2 includes a first conductive member 22A, a second conductive member 22B, and two elastic members 24.

The differences between the present embodiment and the previous embodiment are as follows. The insulating seat 1 includes an insulating main body 1A and an insulating cover 1B. The insulating main body 1A further includes an auxiliary fixing structure 18 in an accommodating space 13 of the insulating main body 1A, and the insulating main body 1A defines fixing slots 18A through the auxiliary fixing structure 18. One side of the insulating main body 1A is an opening side, and the first conductive member 22A and the second conductive member 22B can be placed into the fixing slot 18A of the insulating main body 1A through the opening side. The insulating cover 1B correspondingly includes a sheet structure 1B1. When the insulating main body 1A and the insulating cover 1B are fixed with each other, the sheet structure 1B1 correspondingly covers the opening side of the insulating main body 1A, such that one side of each of the first conductive members 22A and each of the second conductive members 22B are not exposed from the opening side. The insulating cover 1B further includes the two supporting arms 11. After the two terminal assemblies 2 are disposed in the insulating seat 1, one portion of each of the first conductive members 22A and one portion of each of the second conductive members 22B that are exposed from the supporting arms 11 are disposed in the slot 12 of the two supporting arms 11, and an insertion gap is formed between the two terminal assemblies 2 disposed in the slot 12.

An assembling method of the power connector of the present embodiment can be as follows. Firstly, each of the terminal assemblies 2 is inserted into one of the accommodating spaces 13. At this time, the one portion of each of the first conductive members 22A and the one portion of each of the second conductive members 22B are fixedly engaged in the fixing slot 18A of one of the accommodating spaces 13 through one of the auxiliary fixing structures 18, and the two terminal assemblies 2 are electrically isolated and positioned by a baffle 14 of the insulating main body 1A. After the insulating cover 1B and the insulating main body 1A are fixedly engaged with each other, the power connector 100A is completely assembled. In a practical application, the fixing slot 18A defined by each of the auxiliary fixing structures 18 can include a first accommodating space 181 and a second accommodating space 182, and the one portion of each of the first conductive members 22A and the one portion of each of the second conductive members 22B are respectively disposed in the first accommodating space 181 and the second accommodating space 182. At least one section of the first accommodating space 181 and at least one section of the second accommodating space 182 can have a curved shape.

Reference is made to FIG. 14, which is a schematic exploded view of one of the terminal assemblies 2. The first conductive member 22A includes a first contacting arm 22A1 disposed at one end thereof, and the conductive connection sheets 25 disposed at another end thereof. The first contacting arm 22A1 can be connected to the conductive connection sheets 25 through a plurality of soft conductive sheets 27. In one embodiment, one end of the soft conductive sheets 27 can be fixed with each other to form the first contacting arm 22A1. In other embodiments, the first contacting arm 22A1 and the soft conductive sheets 27 can be independent components, and the one end of the soft conductive sheets 27 can be fixed to the first contacting arm 22A1. The soft conductive sheets 27 are not fixed with each other at a section between the first contacting arm 22A1 and the conductive connection sheets 25, so as to form a soft portion. The soft portion can be bendable, and the first contacting arm 22A1 and the conductive connection sheets 25 can relatively move through the soft portion.

The second conductive member 22B includes a plurality of second contacting arms 22B1 disposed at one end thereof, and includes the conductive connection sheets 25 disposed at another end thereof. The second contacting arms 22B1 and the conductive connection sheets 25 can be connected with each other through the soft conductive members 27. In one embodiment, a plurality of partial sections of one end of the soft conductive sheets 27 can be fixed with each other, and can be formed into at least one of the conductive connection sheets 25 by appropriate cutting or other methods. In other embodiments, the soft conductive sheets 27 and the conductive connection sheets 25 can be independent components, and the one end of the soft conductive sheets 27 can be divided into a plurality of sections that are each fixed with one of the conductive connection sheets 25. The soft conductive sheets 27 are not fixed with each other at a section between the second contacting arms 22B1 and the conductive connection sheets 25, so as to form a soft portion. The soft portion can be bendable, and the second contacting arms 22B1 and the conductive connection sheets 25 can relatively move through the soft portion.

The first contacting arm 22A1 and the second contacting arm 22B1 are stacked with each other. When the power connector 100A and the power supply component are mated with each other, the power supply component abuts against the first contacting arm 22A1 and the second contacting arm 22B1 of each of the terminal assemblies 2. One portion of each of the conductive connection sheets 25 of the first conductive member 22A and one portion of each of the conductive connection sheets 25 of the second conductive member 22B are disposed in the first accommodating space 181 and the second accommodating space 182, and are separated by the auxiliary fixing structure 18. Another portion of each of the conductive connection sheets 25 of the first conductive member 22A and another portion of each of the conductive connection sheets 25 of the second conductive member 22B extend out of the first accommodating space 181 and the second accommodating space 182, so as to be electrically connected to the cables disposed in the accommodating space 13.

One end of one of the elastic members 24 in each of the terminal assemblies 2 is fixedly disposed in a first engaging slot 183 of the insulating main body 1A, and another end of said elastic member 24 is disposed at an outer side of the first contacting arm 22A1. One end of another one of the elastic members 24 is fixed to a second engaging slot 184 of the insulating main body 1A, and another end thereof is disposed at an outer side of the second contacting arm 22B1 (i.e., between the first conductive member 22A and the second conductive member 22B).

When the power connector 100A and the power supply component are mated with each other, the first contacting arms 22A1 and the second contacting arms 22B1 are abutted by the power supply component A1. At this time, the two elastic members 24 at one side of the elastic contacting arms 22A1 and the second contacting arms 22B1 are elastically deformed to provide the elastic returning force, such that the first contacting arms 22A1 and the second contacting arms 22B1 stably clamp the power supply component A1. In a practical application, a protruding portion 22A11 can be disposed at one side of each of the first contacting arms 22A1 that is adjacent to the free end, and a protruding portion 22B11 can be disposed at one side of each of the second contacting arms 22B1 that is adjacent to the free end. When the power connector 100A and the power supply component are mated with each other, the protruding portion 22A11 of each of the first contacting arms 22A1 and the protruding portion 22B11 of each of the second contacting arms 22B1 abut against the power supply component, such that the first contacting arms 22A1 and the second contacting arms 22B1 stably clamp the power supply component.

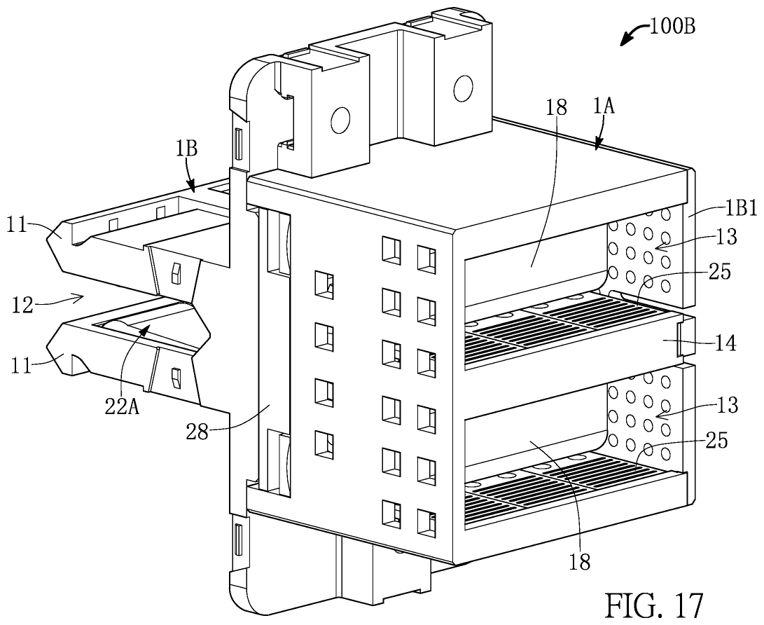

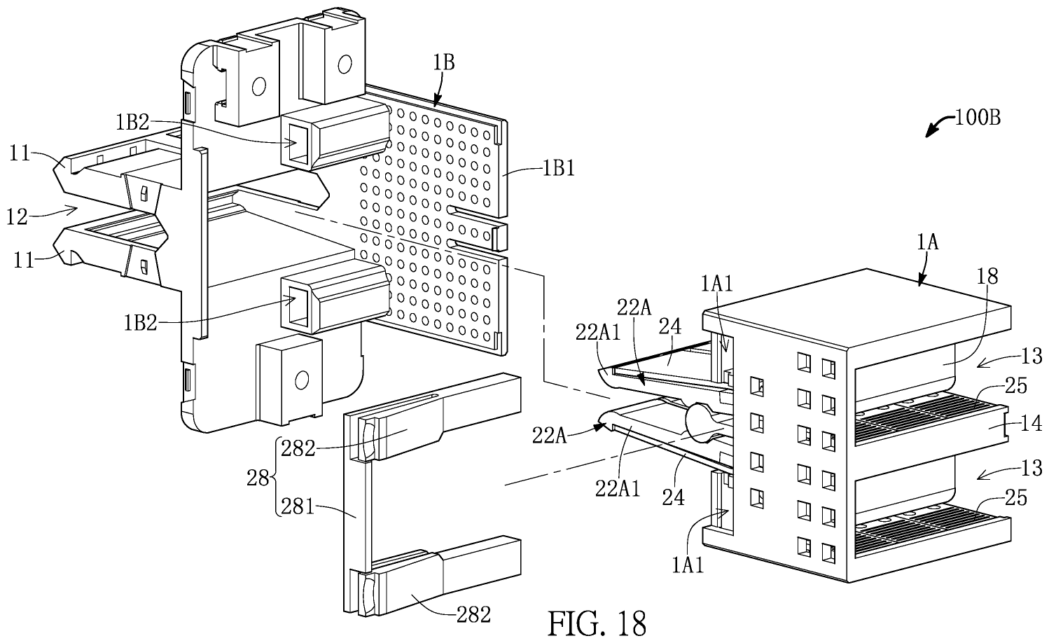

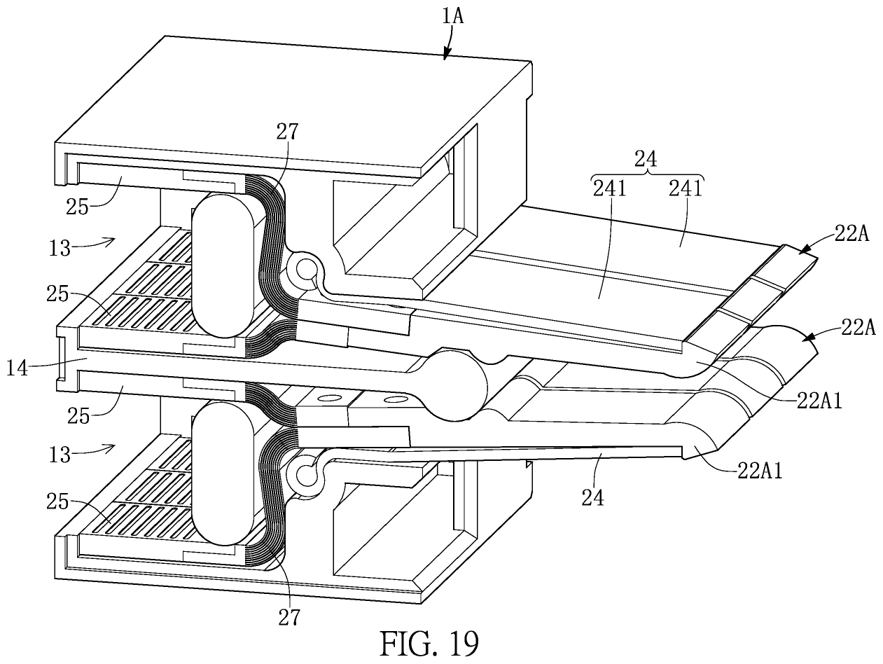

Referring to FIG. 17 to FIG. 19, FIG. 17 is a schematic view of the power connector according to a third embodiment of the present disclosure, FIG. 18 is a schematic partial exploded view of the power connector according to the third embodiment of the present disclosure, and FIG. 19 is a schematic view of the terminal assemblies and one portion of the insulating seat of the power connector according to the third embodiment of the present disclosure.

One of the differences between the present embodiment and the second embodiment is as follows. The power connector 100B further includes an engaging member 28, and the insulating main body 1A and the insulating cover 1B can respectively have a first engaging opening 1A1 and a second engaging opening 1B2. When the insulating main body 1A and the insulating cover 1B are assembled with each other, the first engaging opening 1A1 and the second engaging opening 1B2 are aligned and the engaging member 28 can be insered therein to engage the insulating main body 1A and the insulating cover 1B. In this way, the connection strength between the insulating main body 1A and the insulating cover 1B is enhanced. The engaging member 28 can, for example, include a main body 281 and an elastic structure 282. When the main body 281 is fixedly disposed in the first engaging opening 1A1 and the second engaging opening 1B2, the elastic structure 282 can be deformed and locked in the first engaging opening 1A1, thereby ensuring that the engaging member 28 is positioned in the first engaging opening 1A1 and the second engaging opening 1B2. A user can press the elastic structure 282 for unlocking, so as to take out the engaging member 28.

As shown in FIG. 19, another difference between the present embodiment and the second embodiment is as follows. Each of the terminal assemblies 2 does not include the second conductive member 22B (as shown in FIG. 12). Each of the terminal assemblies 2 includes one elastic member 24. One end of each of the elastic members 24 is fixed to the insulating seat 1, and another end of each of the elastic members 24 is disposed at one side of each of the first conductive members 22A. Another end of each of the elastic members 24 can be divided into two sheet bodies 241 or a plurality of elastic arms, and the two sheet bodies 241 (or the elastic arms) can be correspondingly disposed at one side of the first contacting arm 22A1.

As shown in FIG. 19, yet another difference between the present embodiment and the second embodiment is as follows. Another end of each of the first conductive members 22A can be connected to two of the conductive connection sheets 25. In other words, the two conductive connection sheets 25 disposed in two sides of the same accommodating space 13 are connected to the same first conductive member 22A.

Based on the above descriptions, in the power connector 100B of the present embodiment, since the elastic members 24 are configured to cooperate with the conductive members, the power connector 100B can transmit a large current, and a suitable clamping force can also be maintained between the power connector 100A and the power supply component A1.

### Beneficial Effects of the Embodiments

In conclusion, in the power connector and the terminal assembly provided by the present disclosure, through configuration of the conductive axial column, the conductive member, and the elastic conductive structure, the conductive member can rotate through the conductive axial column after being abutted against. Accordingly, the power connector can transmit a large current, and can also achieve an effect of stably clamping the power supply component.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power connector, comprising:
an insulating seat including two supporting arms disposed at one side thereof, wherein the two supporting arms are spaced apart from each other, and a slot is disposed between the two supporting arms; and
two terminal assemblies, wherein each of the two terminal assemblies includes:
a conductive axial column disposed in the insulating seat;
a conductive member, wherein one end of the conductive member is electrically connected to the conductive axial column, and another end of the conductive member is exposed from the slot; and
at least one elastic conductive structure disposed between the conductive axial column and the conductive member, wherein the at least one elastic conductive structure is electrically connected to the conductive axial column and the conductive member, and the at least one elastic conductive structure includes at least one elastic structure,
wherein, when a power supply component is inserted into the slot, each of the conductive members abutted by the power supply component is configured to rotate relative to the insulating seat through one of the conductive axial columns.

2. The power connector according to claim 1, wherein the one end of each of the conductive members bends to form a bend fixing portion and a hollow accommodating slot, and the hollow accommodating slot is configured to accommodate the conductive axial column and the at least one elastic conductive structure.

3. The power connector according to claim 1, further comprising at least two elastic members, wherein one end of each of the at least two elastic members is fixed to one of the two terminal assemblies or the insulating seat, and each of the at least two elastic members is disposed at one side of a corresponding one of the conductive members; wherein, when each of the conductive members is abutted against and rotates, each of the at least two elastic members is elastically deformed to provide a force to the conductive member for clamping the power supply component.

4. The power connector according to claim 3, wherein each of the conductive axial columns is fixed to the insulating seat, and the one end of each of the at least two elastic members is fixed to the conductive axial column.

5. The power connector according to claim 3, wherein a thickness of each of the at least two elastic members is less than a thickness of each of the conductive members.

6. The power connector according to claim 1, wherein each of the two terminal assemblies further includes a plurality of conductive connection sheets, the conductive connection sheets are spaced apart from each other and disposed in the insulating seat, each of the conductive connection sheets is electrically connected to the conductive axial column, and each of the conductive connection sheets is exposed from another side of the insulating seat; wherein each of the conductive connection sheets is configured to be connected to a cable assembly.

7. The power connector according to claim 6, further comprising a plurality of auxiliary conductive members disposed in the insulating seat, wherein each of the auxiliary conductive members is electrically connected to at least one of the conductive connection sheets and one of the conductive members.

8. The power connector according to claim 7, wherein each of the auxiliary conductive members includes an arced sheet structure disposed at one end thereof, the arced sheet structure includes a plurality of elastic structures disposed thereon, and the elastic structures of the arced sheet structure abut against one of the conductive members.

9. The power connector according to claim 7, wherein the insulating seat has a plurality of engaging slots, and one portion of each of the conductive connection sheets and one portion of an adjacent one of the auxiliary conductive members are engaged in one of the engaging slots.

10. The power connector according to claim 6, wherein the insulating seat has a plurality of engaging slots, and the engaging slots are configured to be engaged with the conductive connection sheets.

11. The power connector according to claim 6, wherein the at least one elastic structure of the at least one elastic conductive structure is an elastic arm.

12. A power connector, comprising:
an insulating seat having a slot disposed at one side thereof; and
two terminal assemblies electrically insulated from each other and disposed in the insulating seat, wherein two ends of the two terminal assemblies are respectively disposed at two sides of the slot, and each of the two terminal assemblies includes:
a conductive axial column disposed in the insulating seat;
a conductive member, wherein one end of the conductive member is electrically connected to the conductive axial column, and is configured to rotate or move relative to the conductive axial column; wherein another end of the conductive member is exposed from the slot; and
at least one conductive connection sheet disposed in the insulating seat, wherein the at least one conductive connection sheet is connected to the conductive axial column, and is configured to be connected to a cable assembly.

13. The power connector according to claim 12, wherein each of the two terminal assemblies further includes at least one elastic conductive structure disposed between the conductive axial column and the conductive member, and the at least one elastic conductive structure, the conductive axial column, and the conductive member are electrically connected to each other.

14. The power connector according to claim 12, wherein, in each of the two terminal assemblies, at least one hollow accommodating slot is further disposed at the one end of the conductive member that is electrically connected to the conductive axial column, and the at least one hollow accommodating slot is configured to accommodate the conductive axial column.

15. The power connector according to claim 12, wherein each of the two terminal assemblies further includes an elastic member having one end disposed in the slot; wherein, when the conductive member moves or rotates relative to the conductive axial column, the elastic member is configured to provide an elastic returning force to the conductive member.

16. The power connector according to claim 15, wherein, in each of the two terminal assemblies, the conductive axial column has a groove, and another end of the elastic member is engaged in the groove.

17. A terminal assembly, comprising:
a conductive axial column;
a conductive member, wherein one end of the conductive member is electrically connected to the conductive axial column, and a plurality of elastic arms are disposed at another end of the conductive member; and
at least one elastic conductive structure disposed between the conductive axial column and the conductive member, wherein the at least one elastic conductive structure, the conductive axial column, and the conductive member are electrically connected to each other, and the at least one elastic conductive structure includes at least one elastic structure;
wherein the conductive member is configured to rotate or move relative to the conductive axial column.

18. The terminal assembly according to claim 17, wherein at least one hollow accommodating slot is disposed at the one end of the conductive member that is electrically connected to the conductive axial column, and the at least one hollow accommodating slot is configured to accommodate the conductive axial column.

19. The terminal assembly according to claim 17, wherein the at least one elastic structure is an elastic arm.

20. The terminal assembly according to claim 17, further comprising an elastic member having one end disposed at one side of the elastic arms, the conductive axial column further has a groove, and another end of the elastic member is engaged in the groove.
